(19) United States
(12) Patent Application Publication
(10) Pub. No.: US 2014/0180954 A1
(43) Pub. Date: Jun. 26, 2014

(54) CONCURRENT DETERMINATION OF SHIPPING MODE AND SHIP UNIT PACKING DURING TRANSPORTATION PLANNING

(71) Applicant: Oracle International Corporation, Redwood Shores, CA (US)

(72) Inventors: Marybeth ROBERTS, Downingtown, PA (US); Yun WANG, Lansdale, PA (US); Ruijin QI, Wayne, PA (US); Sundararajan ARUNAPURAM, West Chester, PA (US)

(73) Assignee: ORACLE INTERNATIONAL CORPORATION, Redwood Shores, CA (US)

(21) Appl. No.: 14/107,603

(22) Filed: Dec. 16, 2013

Related U.S. Application Data
(60) Provisional application No. 61/740,442, filed on Dec. 20, 2012.
(60) Provisional application No. 61/785,544, filed on Mar. 14, 2013.

(51) Int. Cl. G06Q 10/08

(52) U.S. Cl. CPC G06Q 10/08345
USPC 705/335

(57) ABSTRACT

A method, system, and computer program product for shipping route selection and transportation planning systems. The computer-implemented method commences upon receiving a set of candidate transportation carrier descriptions, individual ones of the set of candidate transportation carrier descriptions having one or more shipping mode options and having one or more shipping unit options. Then, the method evaluates combinations of using multiple transportation carriers that provide any of the one or more shipping mode options with compatible shipping unit options to determine a combination cost for each of the combinations. Based on the combination costs, the method selects an equipment option that corresponds to the lowest combination cost. Low-cost itineraries can be formed by calculating the cost of a particular itinerary by summing combination costs of constituent legs.

### RELATED APPLICATIONS

The present application claims the benefit of priority to co-pending U.S. Patent Application Ser. No. 61/740,442, filed Dec. 20, 2012, entitled “SYSTEMS METHODS AND APPARATUS FOR DYNAMIC PALLET BUILDING” (Attorney Docket No. ORA130491-US-PSP); and the present application claims the benefit of priority to co-pending U.S. Patent Application Ser. No. 61/785,544, filed Mar. 14, 2013, entitled “SYSTEMS METHODS AND APPARATUS FOR DYNAMIC PALLET BUILDING” (Attorney Docket No. ORA130491-US-PSP-1), both of which are hereby incorporated by reference in their entirety.

The present application is related to co-pending U.S. patent application Ser. No. ______, entitled “FINDING MINIMUM COST TRANSPORTATION ROUTES FOR ORDERS THROUGH A TRANSPORTATION NETWORK” (Attorney Docket No. ORA130515-US-NP), filed on even date herewith, which is hereby incorporated by reference in its entirety; and the present application is related to co-pending U.S. patent application Ser. No. ______, entitled “A CARRIER CAPACITY AWARE MULTI-STOP SHIPMENT GENERATOR” (Attorney Docket No. ORA130516-US-NP), filed on even date herewith, which is hereby incorporated by reference in its entirety; and the present application is related to co-pending U.S. patent application Ser. No. ______, entitled “COST AND LATENCY REDUCTIONS THROUGH DYNAMIC UPDATES OF ORDER MOVEMENT THROUGH A TRANSPORTATION NETWORK” (Attorney Docket No. ORA130492-US-NP), filed on even date herewith, which is hereby incorporated by reference in its entirety; and the present application is related to co-pending U.S. patent application Ser. No. ______, entitled “COST AND LATENCY REDUCTIONS THROUGH DYNAMIC UPDATES OF ORDER MOVEMENT THROUGH A TRANSPORTATION NETWORK” (Attorney Docket No. ORA130492-US-CIP-1), filed on even date herewith, which is hereby incorporated by reference in its entirety.

Certain aspects in some embodiments of the present application are related to material disclosed in pending U.S. patent application Ser. No. 13/111,120, entitled “FRAMEWORK FOR OPTIMIZED PACKING OF ITEMS INTO A CONTAINER” filed on May 19, 2011, the content of which is incorporated by reference in its entirety in this application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of shipping route selection and transportation planning systems and more particularly to techniques for concurrent determination of shipment mode and ship unit packing during transportation planning

### BACKGROUND

In the context of global commerce, certain goods often are manufactured in locations that are distant from the end customer or market where the goods will be put to use. In some cases the favorable manufacturing costs far outstrip the cost of shipping the manufactured goods to even distant or hard-to-reach locations. Thus, transportation networks have sprung up to handle movement of goods from more-or-less any place on earth to more-or-less any other place on earth. The movement of goods from point A to point B might involve an itinerary covering any days and involving many different modes of transportation (e.g., short haul by truck, interstate by air, intercontinental by ship, etc.).

Legacy techniques approach cost containment by amalgamating goods into appropriate ship units (e.g., onto pallets or into containers or cartons) and then scheduling the movement of the ship unit onto an itinerary. This legacy technique where the goods are amalgamated into ship units (e.g., palletized) and then scheduled for movement through the transportation network from source to destination fails to consider situations when a cheaper transportation mode could have been selected had it not been that the approach had already amalgamated the goods into quanta.

Otherwise stated, if the consolidation is determined before the transportation mode is determined, then the selection of the transportation mode will be artificially constrained (due to the components of the consolidated orders of goods). Conversely, if the technique does not know the transportation mode before consolidating the orders of goods, then the consolidation cannot be optimized with respect to the transportation mode options. The techniques for making decisions affecting consolidation and packing should be run in an interrelated manner with the making of decisions that affect the selection of transportation modes.

Moreover, none of the aforementioned technologies have the capabilities to perform the herein-disclosed techniques for concurrent determination of shipping mode and ship unit packing during transportation planning. Therefore, there is a need for an improved approach.

### SUMMARY

The present disclosure provides an improved method, system, and computer program product suited to address the aforementioned issues with legacy approaches. More specifically, the present disclosure provides a detailed description of techniques used in methods, systems, and computer program products for concurrent determination of shipping mode and ship unit packing during transportation planning.

For certain transport modes (e.g., overland long haul, overland local haul, airborne cargo plane, seagoing vessel, etc.) the number of ship units (e.g., packages, parcels, pallets, containers, flatbed trailers, etc.) that are used in the shipments impacts the overall cost of the shipments. Using the techniques disclosed herein, it is possible to compare different modes of transportation that use different ship units based on the cost of a particular ship unit using a particular transport mode over a particular leg of an itinerary. For example, when shipping via overland local courier for an order weighing 130 pounds, it might be cheaper to create two packages, each at 65 pounds. However, if building a pallet destined for a container to be loaded onto an ocean-going vessel, splitting the 130 pound order into two parcels would most likely not affect the cost. The decision of how to package depends on the mode decision and vice-versa. Thus the techniques disclosed herein consider the packaging and ship unit options along with the route and mode options. In some embodiments, when a shipment has multiple orders that individually do not fill up “full” ship units, it is often possible to create full ship units by building ship units that span across orders. Consolidating items across different orders can result in fewer overall ship units, which in turn can reduce the overall transportation costs when using certain compatible transportation modes.

The foregoing techniques can be implemented in a computer. A computer-implemented method commences upon receiving a set of candidate transportation carrier descriptions, individual ones of the set of candidate transportation carrier descriptions having one or more corresponding shipping mode options and having one or more corresponding shipping unit options. Then, the method evaluates combinations of using any of the one or more shipping mode options with compatible shipping unit options to determine combination costs. Based on the calculated combination costs, the method selects equipment options that correspond to the lowest combination cost. Low cost itineraries can be formed by calculating the cost of a particular itinerary by summing combination costs of constituent legs.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A is a diagram of a flow of goods through a transportation network to exemplify a technique for concurrent determination of shipping mode and ship unit packing during transportation planning, according to some embodiments.

FIG. 1B is a data flow diagram depicting an operation sequence to accomplish concurrent determination of shipping mode and ship unit packing during transportation planning, according to some embodiments.

FIG. 2 is a schematic representation of a multi-mode intercontinental transportation network as used by systems implementing concurrent determination of shipping mode and ship unit packing during transportation planning, according to some embodiments.

FIG. 3 is a mode-to-equipment correspondence chart as used by systems implementing concurrent determination of shipping mode and ship unit packing during transportation planning, according to some embodiments.

FIG. 4A is a data flow diagram depicting an operation sequence used for concurrent determination of shipping mode and ship unit packing during transportation planning, according to some embodiments.

FIG. 4B is a data flow diagram depicting an operation sequence to consolidate partially-packed ship units after concurrent determination of shipping mode and ship unit packing during transportation planning, according to some embodiments.

FIG. 5 is a depiction of a location description GUI used in describing location characteristics in systems for concurrent determination of shipping mode and ship unit packing during transportation planning, according to some embodiments.

FIG. 6 is a depiction of a transportation handling unit description GUI used in describing transportation handling unit characteristics in systems for concurrent determination of shipping mode and ship unit packing during transportation planning, according to some embodiments.

FIG. 7 is a block diagram of a system for concurrent determination of shipping mode and ship unit packing during transportation planning, according to some embodiments.

FIG. 8 depicts a block diagram of an instance of a computer system suitable for implementing an embodiment of the present disclosure.

### DETAILED DESCRIPTION

Some embodiments of the present disclosure address the challenge of lowering shipping costs by employing techniques for concurrent determination of shipping mode and ship unit packing during transportation planning. More particularly, disclosed herein and in the accompanying figures are exemplary environments, methods, and systems for implementing concurrent determination of shipping mode and ship unit packing during transportation planning.

### Overview

Solving least-cost-routing problems for movement of goods through a transportation network is considered a notoriously difficult problem. Unfortunately, legacy approaches have over-simplified the problem to the extent that many advantageous solutions and/or optimal or near optimal solutions are not considered at all. For example, some legacy techniques perform order amalgamation and packing before determining a shipping mode. Thus, using this legacy technique, by the time the shipping mode is selected, at least some of the lower-cost shipping mode options are eliminated due to the artificial constraints imposed by the packing and amalgamation operations.

For example, a higher-cost overland transportation mode (e.g., long haul truck) might be selected for moving a pallet of goods merely because the pallet contains a small package that is intended to reach its destination one day earlier than the remainder of the goods on the pallet.

As discussed herein, the cost penalty of prematurely determining packing options before selecting a mode can be solved by considering costs of combinations of packing options (e.g., shipping units and their characteristics) and their corresponding transportation mode options before selecting the mode. The transportation carrier(s) and transportation modes can be selected based on a calculated cost of the combination of using a particular transportation mode (e.g., long haul truck) that uses a particular type of shipping unit (e.g., pallet).

As pertaining to some embodiments disclosed herein, the decision of what packing options or consolidation options to choose depends on the available transportation mode options and vice-versa. Thus, the techniques disclosed herein consider the packing and ship unit options along with the route and mode options when calculating costs. In some embodiments, when a shipment has multiple orders, any one of which do not fill up “full” ship units, it is often possible to create full ship units by building ship units that span across orders. Consolidating items across different orders can result in fewer overall ship units, which can in turn reduce the overall transportation costs when using certain compatible transportation modes.

Many packing options emerge in the context of transglobal shipping, and carriers can introduce still further packing options. Strictly as examples, Table 1 lists some packing options.

TABLE 1
Packing options

| Packing Name | Comment |
|---|---|
| Prepack | Pre-packing before considering available |
| | transportation mode options |
| One to one | Assume only one available carrier (or only |
| | one transportation mode option) |
| No mix | Constraint: Do not mix commodities |
| Allow mixed goods | Relaxation: Allow mixed commodities |
| Allow mixed using a small | Relaxation: Allow mixed commodities |
| quantity threshold | within a threshold limitation |

### DEFINITIONS

Some of the terms used in this description are defined below for easy reference. The presented terms and their respective definitions are not rigidly restricted to these definitions—a term may be further defined by the term's use within this disclosure.
The terms “transportation mode(s)” and “shipping mode(s)” and “shipment mode(s)” are used interchangeably.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

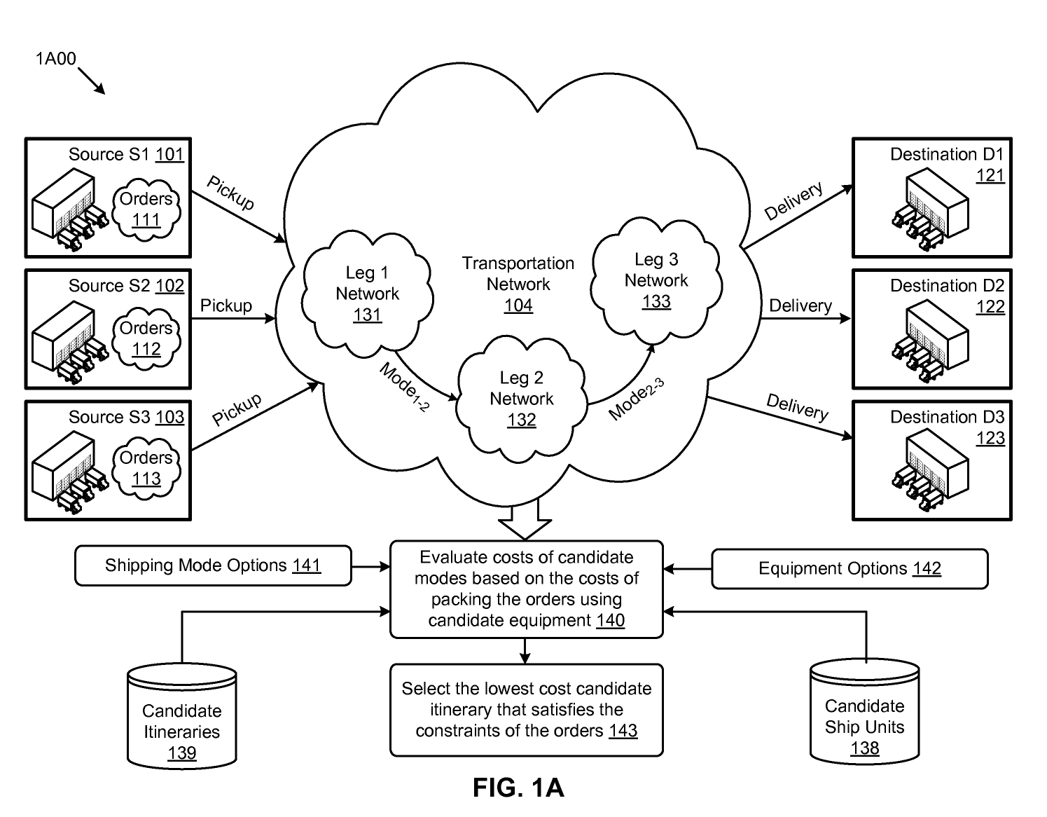

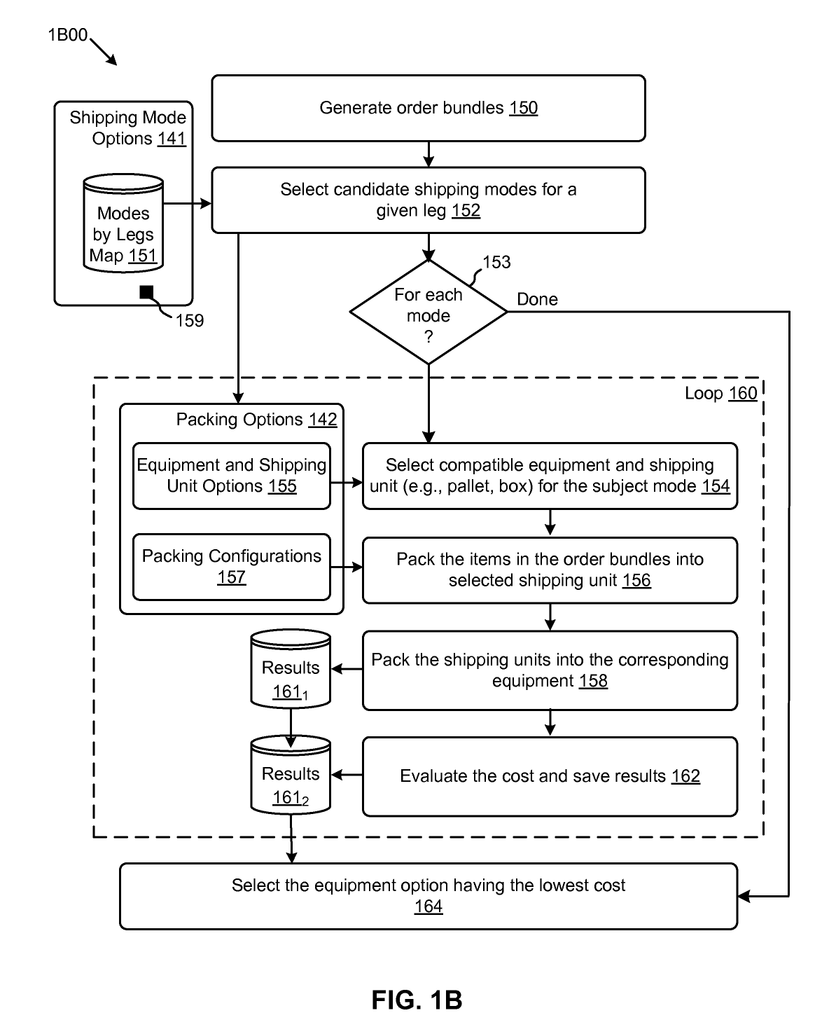

FIG. 1A is a diagram of a flow 1A00 of goods through a transportation network to exemplify a technique for concurrent determination of shipping mode and ship unit packing during transportation planning. As an option, the present flow 1A00 or any aspect thereof may be implemented in the context of the architecture and functionality of the embodiments described herein. Also, the flow 1A00 or any aspect thereof may be implemented in any desired environment.

As shown, orders are to be transported from a source point through a transportation network 104 in order to reach their intended respective destinations. More specifically, orders in the form of descriptions of goods (e.g., order 111, order 112, and order 113) that are to be picked-up from source locations (e.g., source S1 101, source S2 102, source S3 103) and routed through various legs (e.g., leg 1, leg 2, leg 3) to reach their respective destination locations (e.g., destination D1 121, destination D2 122, destination D3 123). Each leg may include segments of a particular transportation mode through a sub-network. As shown, the transportation network 104 represents a global transportation network that encompasses many different modes of transport (e.g., truck, airplane, air pack, rail, transoceanic vessel, parcel service, courier, etc.) and each mode of transport can include any number of transportation carriers, which carriers can be coordinated to form a sub-network. A given order traverses from source to destination in accordance with an itinerary, which comprises any number of constituent legs, where a leg is defined as a distance traveled using one particular transportation mode (e.g., truck, air, rail, etc.). The shown traversals from source to destination are in accordance with an itinerary that includes transportation using carriers in leg 1 network 131, then carriers in the leg 2 network 132, and then carriers in the leg 3 network 133 to the destinations shown.

Shipping costs can be managed using techniques to evaluate costs of candidate itineraries 139 based on the packing of the orders (see operation 140). The procedures of operation 140 can take in data in the form of transportation carrier descriptions, possibly including any descriptions or forms of shipping mode options 141 (which can include detailed descriptions of individual shipping modes 159), and the procedures of operation 140 can take in data in the form of packing options 142. A number of compatible combinations of transportation mode options and equipment options can be evaluated (see operation 140) and the set of evaluated combinations of transportation mode options and equipment options can be further evaluated to determine the lowest cost candidate itineraries that satisfies the constraints of the orders (see operation 143). Further processing can resolve to a single selected itinerary, and instructions can be sent to the carriers that are to participate in the movement of the goods in accordance with the single selected itinerary.

A plurality of compatible combinations of transportation modes over the legs of candidate itineraries and evaluation of corresponding equipment options (e.g., using compatible ship units 138) can be concurrently evaluated using techniques disclosed herein. One such technique is presently discussed with respect to the data flow diagram of FIG. 1B, as follows.

FIG. 1B is a data flow diagram depicting an operation sequence 1B00 to accomplish concurrent determination of shipping mode and ship unit packing during transportation planning. As an option, the present operation sequence 1B00 or any aspect thereof may be implemented in the context of the architecture and functionality of the embodiments described herein. Also, the operation sequence 1B00 or any aspect thereof may be implemented in any desired environment.

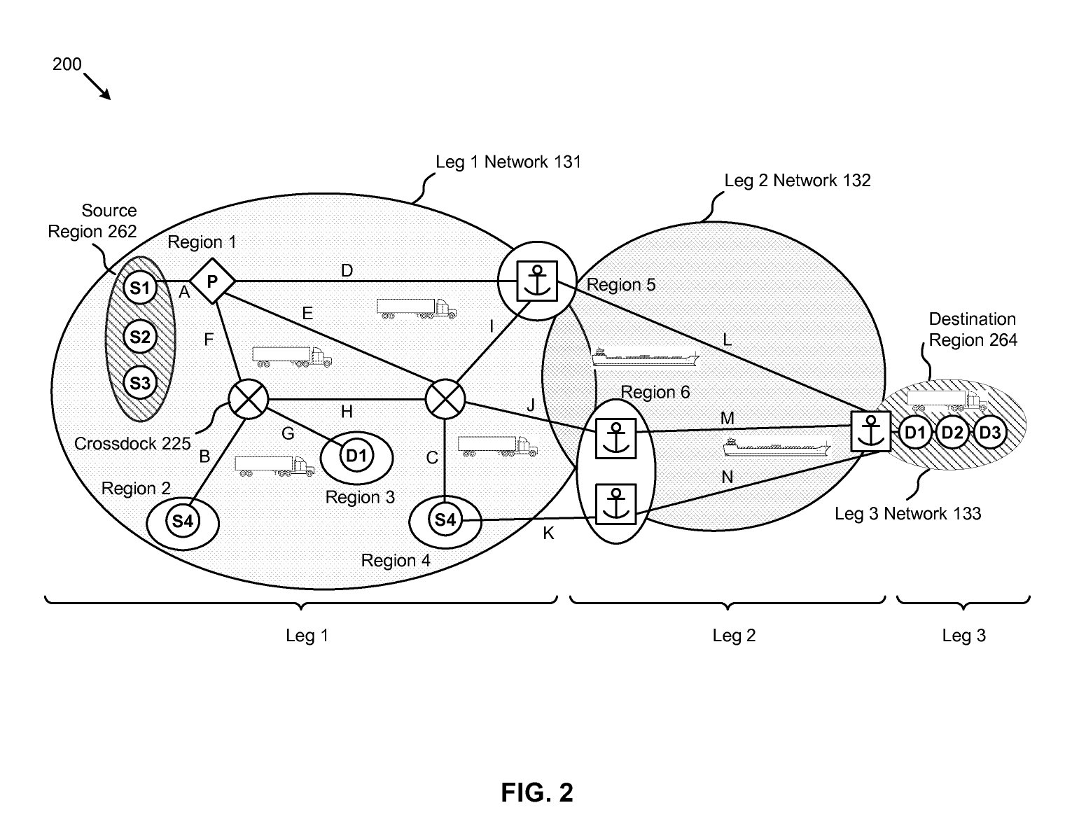

The embodiment as given in the operation sequence 1B00 commences by generating order bundles (see operation 150). The unit described herein as an order bundle can be defined in various ways. For example, an order bundle can be defined as a group of orders that have sources situated at locations within a particular proximity (e.g., see regions of FIG. 2) and have destinations situated at locations within another particular proximity. Further, an order bundle can be defined to include orders that have a delivery date within some date or time threshold. The foregoing descriptions of order bundles are merely examples, and other rules or definitions can be applied during the formation of order bundles. In illustrative cases, an order within an order bundle can share at least a portion of an itinerary with other orders in the same order bundle.

Continuing this flow, and following the foregoing example of an order bundle being defined (at least in part) on the geographic locations of source and destination, then the flow proceeds to select and evaluate a set of covering transportation modes. In selecting and evaluating transportation modes available for a particular leg (see operation 152) the selection procedure (e.g., within a selection unit) can access a list of modes that can be codified in a dataset such as is shown in the modes by legs map 151 or in a table or relation in a database. In some cases a listed mode may be inappropriate; for example, an order to be shipped from Chicago to Los Angeles would not use an oceangoing mode of transportation. In other cases, the characteristics of the order bundle are such that one or more transportation modes are appropriate, for example an order bundle sourced from a region near Los Angeles to a region near Munich might be shipped over a transoceanic leg as well using two overland legs.

In practice, certain equipment corresponds to or is compatible with a given transportation mode used in an itinerary. Also certain equipment corresponds to or is compatible with one or more ship units. Table 2 gives some examples.

TABLE 2
Compatibility table

| Transportation | | |
|---|---|---|
| Mode | Equipment Options | Ship units |
| Overseas | Ocean-going vessel | {entire vessel, container, pallet, |
| | | carton, big box} |
| Airborne | Cargo plane | {entire vessel, container, pallet, |
| | | carton, big box} |
| Airborne | Small aircraft | {entire vessel, carton, big box, small- |
| | | volume parcel, light-weight parcel} |
| Overland | {trailer, flatbed, refrigeration | {container, pallet, carton, big box} |
| (long haul) | trailer} | |
| Rail | {container, flatbed railcar, | {container, pallet, carton, big box} |
| (long haul) | refrigeration boxcar} | |
| Overland | {small truck, medium truck} | {pallet, carton, big box} |
| (short haul) | | |
| Courier | Small vehicle | {small-volume parcel, light-weight |
| | | parcel} |

Now, continuing, the flow comprises a loop (see loop 160) to evaluate transportation modes together with compatible equipment and ship units (see equipment and shipping unit options 155). The loop to evaluate transportation modes comprises steps performed over each of the selected modes (see decision 153). The loop processes each mode as follows:
Select compatible equipment and corresponding ship units (see operation 154).
Evaluate packing configurations (see packing configuration 157) for packing the items of the order bundles into a ship unit (see operation 156). There may be many feasible packing configurations.
Pack the shipping units into the corresponding equipment (see operation 158). There may be many feasible possibilities to pack the shipping units into the corresponding equipment.
Evaluate the feasibility and cost of each possibility (see operation 162), and publish various forms of results 161 of the evaluations. Strictly as examples, the results of the evaluations can come in the form results including cost evaluations 161₂, or the results of the packing can come in the form results including feasibility or preferences (e.g., arrival time preferences) of the equipment option possibilities 161₁.

When the set of the options (e.g., combinations of transportation modes, equipment, and ship units) have been evaluated down to a cost, then select the equipment that has the lowest cost (see operation 164). Some embodiments include further steps such that legs are identified by other processes, and/or crossdocks or distribution centers are considered.

In some cases the results of evaluating the cost of each possibility (see operation 162) are stored in an in-memory data structure; in other cases, the results of evaluating the cost of each possibility are stored in a database (as shown).

Now, observing certain aspects of the loop 160, it emerges that evaluating the cost of each possibility includes the costs related to the ship unit as well as the costs related to the mode of transportation. Further, boundary conditions such as packing only a partial pallet (which might still incur the cost of a full pallet), or such as packing only a partial container (which might still incur the cost of a full container), or such as packing an entire truck or vessel (which might trigger a volume discount) are considered in the costing.

The loop distinguishes over alternatives in at least the following regards as depicted in Table 3:

TABLE 3
Selected distinguishing features

| Serial Regime Operations | Concurrent Regime Operations |
|---|---|
| Build ship units before evaluating | Perform evaluation of |
| transportation mode | combinations of ship units |
| | and transportation mode concurrently |
| Select transportation mode before | Perform evaluation of |
| evaluating costs associated with | combinations of ship units |
| building ship units | and transportation mode concurrently |
| Build ship units before selecting | Perform evaluation of combinations |
| transportation equipment | of ship units and equipment |
| | concurrently |
| Consider an order as an atomic unit | Consider each item or component of |
| for cost calculations | an order as a separately costed item |

FIG. 2 is a schematic representation of a multi-mode intercontinental transportation network 200 as used by systems implementing concurrent determination of shipping mode and ship unit packing during transportation planning. As an option, the present multi-mode intercontinental transportation network 200 or any aspect thereof may be implemented in the context of the architecture and functionality of the embodiments described herein. Also, the multi-mode intercontinental transportation network 200 or any aspect thereof may be implemented in any desired environment.

The schematic representation depicts several source points labeled as “S1”, “S2”, and “S3” at which source points various goods are readied for shipment based on orders. The orders flow through a multi-mode intercontinental transportation network 200 using available modes of transportation. For example, an order might traverse leg 1 using an overland carrier, and leg 2 using an overseas carrier, and leg 3 again using an overland carrier. Traversal over a particular leg uses a single mode of transportation, and a traversal from point to point within a leg might include multiple segments (e.g., see segment “A”, segment “B”, segment “C”, segment “D”, segment “E”, segment “F”, segment “G”, segment “H”, segment “I”, segment “J”) and might include a stopover at a crossdock (e.g., crossdock 225). In some situations multiple carriers can form a network, and a given leg can organize such multiple carriers into a leg network (e.g., leg 1 network 131, leg 2 network 132, leg 3 network 133). Traversal through leg networks can be combined to form an itinerary, which itinerary may include specific arrival and departure schedules.

In some cases multiple source points are proximally located (as shown, see “S1”, “S2”, and “S3” near source region 262) and in some cases multiple destination points are proximally located (as shown, see “D1”, “D2”, and “D3” near destination region 264).

The aforementioned shipping mode options 141 can include individual shipping modes 159, any of which may be included in a mapping between a particular shipping mode 159 and corresponding equipment and compatible ship units. Such a mapping is presently discussed.

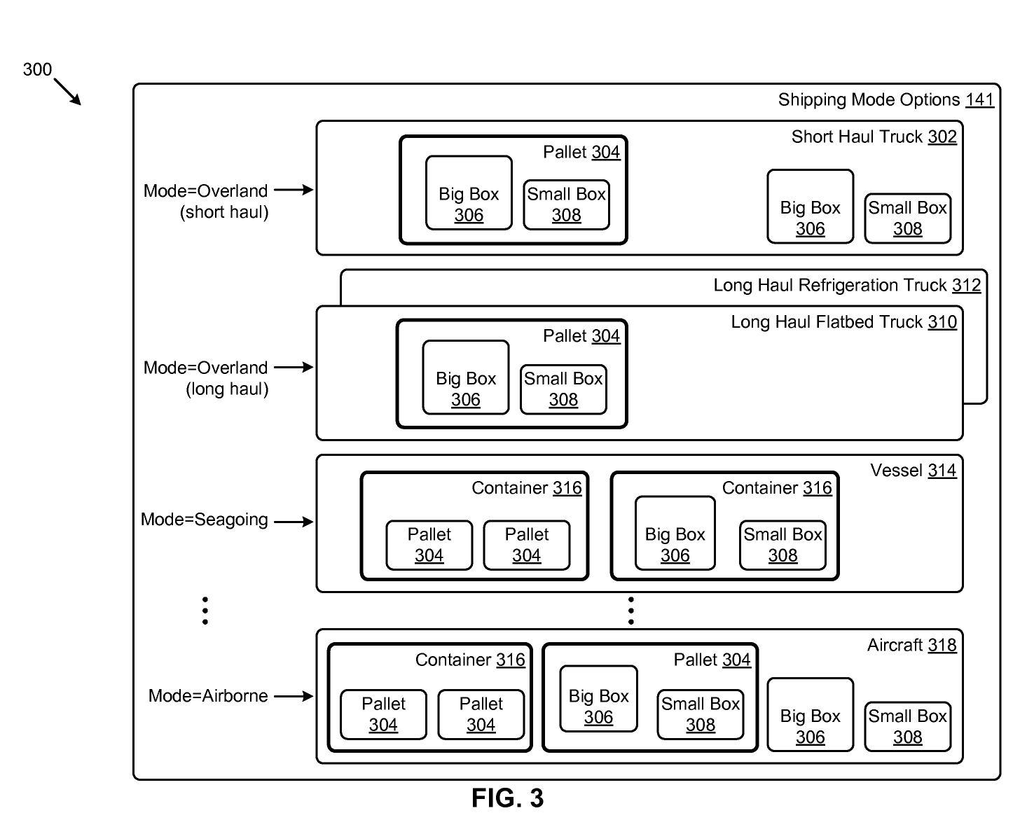

FIG. 3 is a mode-to-equipment correspondence chart 300 as used by systems implementing concurrent determination of shipping mode and ship unit packing during transportation planning. As an option, the present mode-to-equipment correspondence chart 300 or any aspect thereof may be implemented in the context of the architecture and functionality of the embodiments described herein. Also, the mode-to-equipment correspondence chart 300 or any aspect thereof may be implemented in any desired environment.

The correspondence chart suggests one or more equipment options that correspond to a transportation mode. For example, an overland mode such as “mode=overland (short haul)” corresponds to a short haul truck 302, as shown. Or, for example, an overseas mode such as “mode=seagoing” corresponds to a seagoing vessel 314. Further, a particular type or configuration of equipment can correspond to compatible ship units. Again referring to the mapping of the mode-to-equipment correspondence chart 300, a seagoing vessel 314 is compatible with a container 316, which in turn is compatible with a pallet 304, and/or is compatible with a big box 306 and/or a small box 308.

As shown, the equipment can include a variety of vehicles (e.g., a short haul truck 302, a long haul flatbed truck 310, a long haul refrigeration truck 312, a seagoing vessel 314, aircraft 318, etc.). The foregoing listing of equipment is merely illustrative, and further equipment and ship units and mappings are reasonable and envisioned.

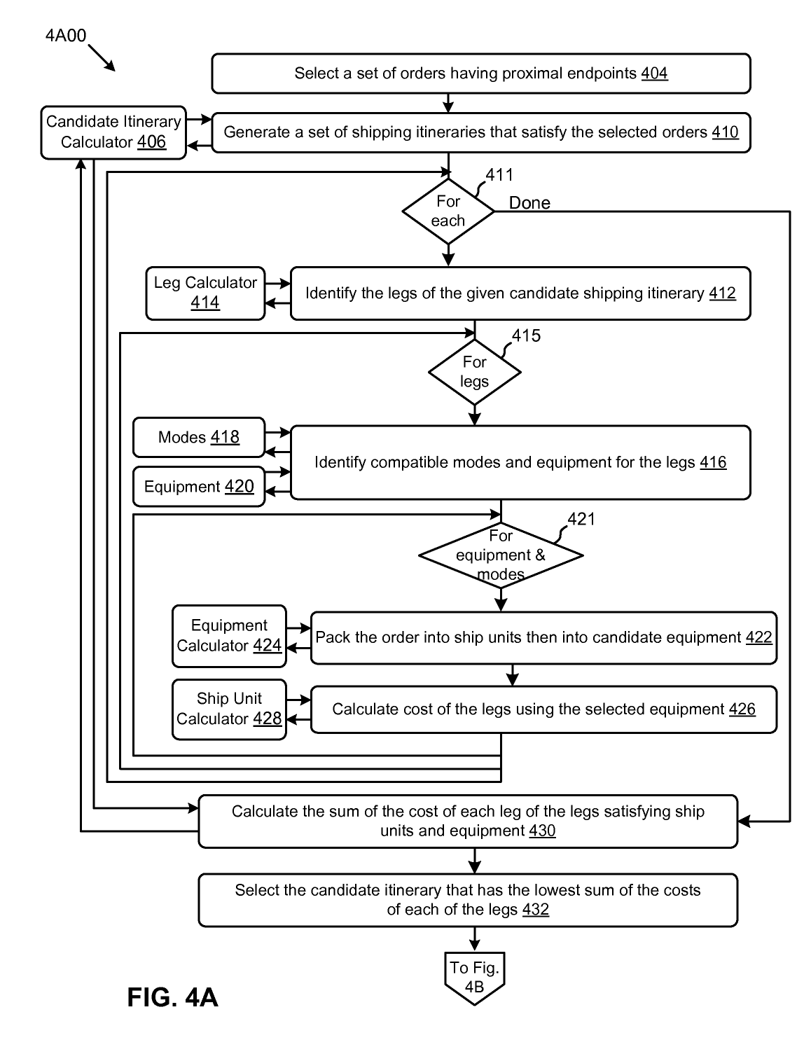

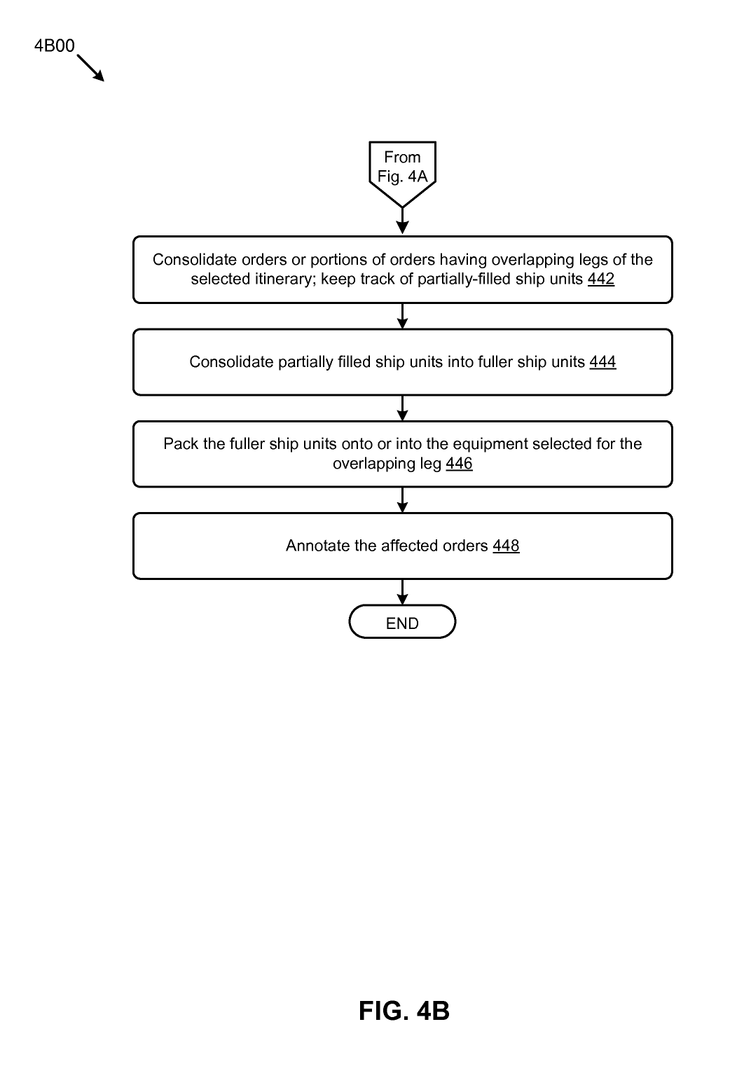

FIG. 4A is a data flow diagram depicting an operation sequence 4A00 used for concurrent determination of shipping mode and ship unit packing during transportation planning. As an option, the present operation sequence 4A00 or any aspect thereof may be implemented in the context of the architecture and functionality of the embodiments described herein. Also, the operation sequence 4A00 or any aspect thereof may be implemented in any desired environment.

As shown, operation sequence 4A00 commences by selecting a set of orders that share proximal endpoints such as pickup points or sources within the same region and destinations within the same region (see operation 404). Then, using any known technique, generate a set of itineraries that satisfy the selected orders (see operation 410). The operation to generate a set of itineraries that satisfy the selected orders might use a router (e.g., a candidate itinerary calculator 406). As is known in the art, multiple itineraries can be formed such that the timing of any scheduled order pick-up and any scheduled order delivery are satisfied. Such itineraries can be formed even without consideration of the components of the order. Processing to accommodate considerations of the components of the order can be deferred until a later time. For example, selection of a long haul refrigeration truck 312 (e.g., if a component of an order comprises a perishable item such as milk) can be deferred until a later step.

As shown, when at least some of the candidate itineraries have been generated, processing can proceed to an evaluation of each itinerary until done (see decision 411). Such an evaluation can include dividing an itinerary into constituent legs (see operation 412), possibly using a leg calculator (see operation 414). For each leg (see decision 415), there corresponds a particular transportation mode, and further, for a particular transportation mode, there is a mapping to equipment (for example, see mode-to-equipment correspondence chart 300). Determining the available modes for a leg can be facilitated by a process (e.g., see modes 418), and determining the available equipment for a particular mode can be facilitated by a process (e.g., see modes 420). For each type of candidate equipment enumerated in operation 416 (which candidate equipment can correspond to one or more modes), a packing process packs the orders into the particular candidate equipment (see operation 422), possibly using any combination of candidate equipment and compatible ship units (see equipment calculator 424 and ship unit calculator 428), and the cost of a particular leg using the selected (and packed) candidate equipment is calculated (see operation 426). The foregoing steps are performed in a loop covering the identified equipment/modes (see decision 421).

The aforementioned costs can be attributed to a leg by virtue of a corresponding unit of candidate equipment used on the leg. For example, a container to be shipped for a leg (e.g., from location A to location B) using a seagoing vessel might cost $X. Or, a container to be shipped for a leg (e.g., from location B to location C) using a courier van carrying a parcel might cost $Y.

When the costs of packing for all legs (see decision 415) of all itineraries (see decision 411) have been evaluated (e.g., see the depicted loop-terminating operation 426), the processing of operation sequence 4A00 proceeds to calculate the sums of all of the costs of each leg of the candidate itineraries (see operation 430). In many cases, multiple equipment options and multiple ship unit options will be considered. The operation sequence 4A00 concludes by selecting the candidate itinerary that has the lowest sum of the costs of each of the legs (see operation 432). As such, operation sequence 4A00 is one implementation of a system for evaluating shipping modes and ship unit packing in concurrence such that a lowest cost candidate itinerary is selected. The selected itinerary can be further loaded using order consolidation techniques, and the selected itinerary can be annotated in preparation for preparing movement instructions. Such consolidation and annotation techniques are presently discussed.

FIG. 4B is a data flow diagram depicting an operation sequence 4B00 to consolidate partially-packed ship units after concurrent determination of shipping mode and ship unit packing during transportation planning. As an option, the present operation sequence 4B00 or any aspect thereof may be implemented in the context of the architecture and functionality of the embodiments described herein. Also, the operation sequence 4B00 or any aspect thereof may be implemented in any desired environment.

In some cases, it is convenient to load the selected itinerary with additional orders. Referring again to processes for selecting a set of orders that share proximal endpoints (see operation 404) the itinerary selected in operation 432 might comprise one or more crossdocks or weigh-points such that additional orders that pass through such crossdocks or weigh-points can be consolidated. The processes of operation sequence 4B00 can include consolidating orders or portions of orders having overlapping legs with respect to the itinerary selected in operation 432, and such a process can keep track of partially-filled ship units (see operation 442). Then partially-filled ship units can be further consolidated into more fully-packed ship units (see operation 444). The more fully-packed ship units can in turn be loaded onto or into compatible equipment (see operation 446) and the affected orders (e.g., those orders for which consolidation has occurred) can be annotated (see operation 448). Movement instructions can be accordingly created or updated.

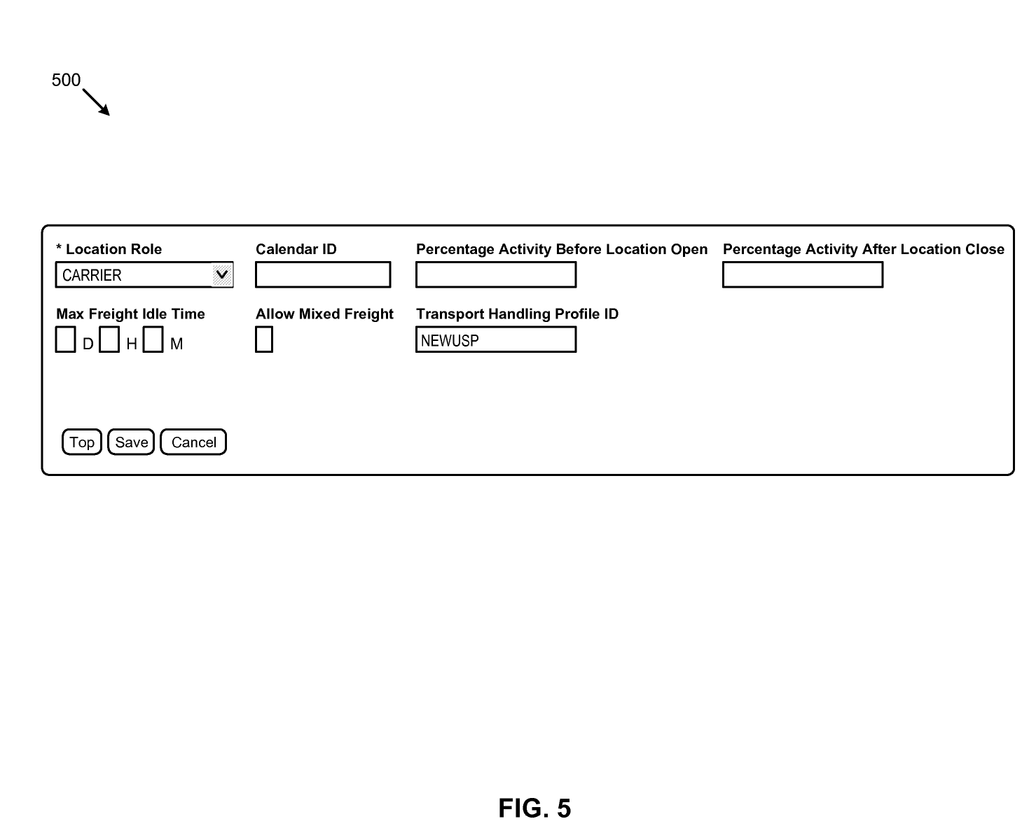

FIG. 5 is a depiction of a location description GUI 500 used in describing location characteristics in systems for concurrent determination of shipping mode and ship unit packing during transportation planning. As an option, the present location description GUI 500 or any aspect thereof may be implemented in the context of the architecture and functionality of the embodiments described herein. Also, the location description GUI 500 or any aspect thereof may be implemented in any desired environment.

Some of the aforementioned techniques involve calculations on attributes that influence the generation of itineraries, and/or legs, and/or movements. Aspects of such attributes can be established and changed and/or otherwise maintained by a user by use of a location description GUI 500. As shown, such a location description GUI can identify a location and its role, a rule or rules pertaining to freight idle time, and other characteristics.

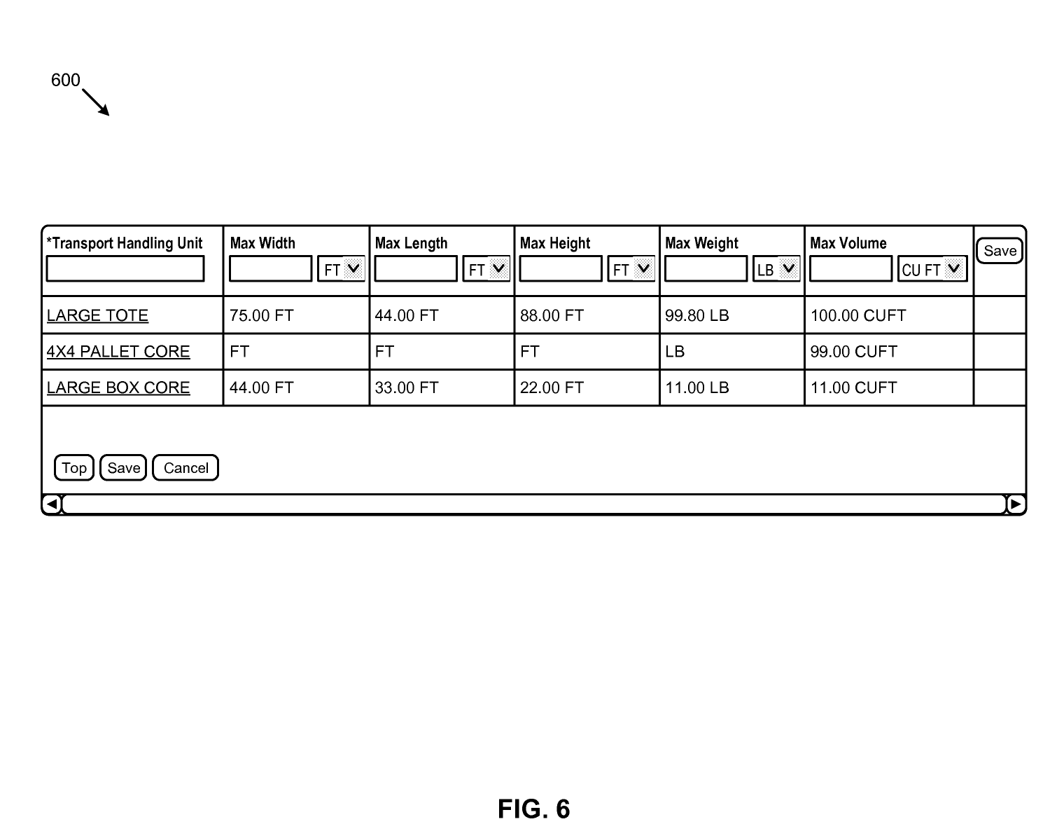

FIG. 6 is a depiction of a transportation handling unit description GUI 600 used in describing transportation handling unit characteristics in systems for concurrent determination of shipping mode and ship unit packing during transportation planning. As an option, the present transportation handling unit description GUI 600 or any aspect thereof may be implemented in the context of the architecture and functionality of the embodiments described herein. Also, the transportation handling unit description GUI 600 or any aspect thereof may be implemented in any desired environment.

Some of the aforementioned techniques involve calculations that are at least partly based on attributes that influence the packing of ship units. Aspects of such attributes can be established and changed and/or otherwise maintained by a user by use of a transportation handling unit description GUI 600. As shown, such a transportation handling unit description GUI can identify a transportation handling unit by name, and can describe dimensions and weight limitations and/or a volume, and/or other characteristics.

### Additional Embodiments of the Disclosure

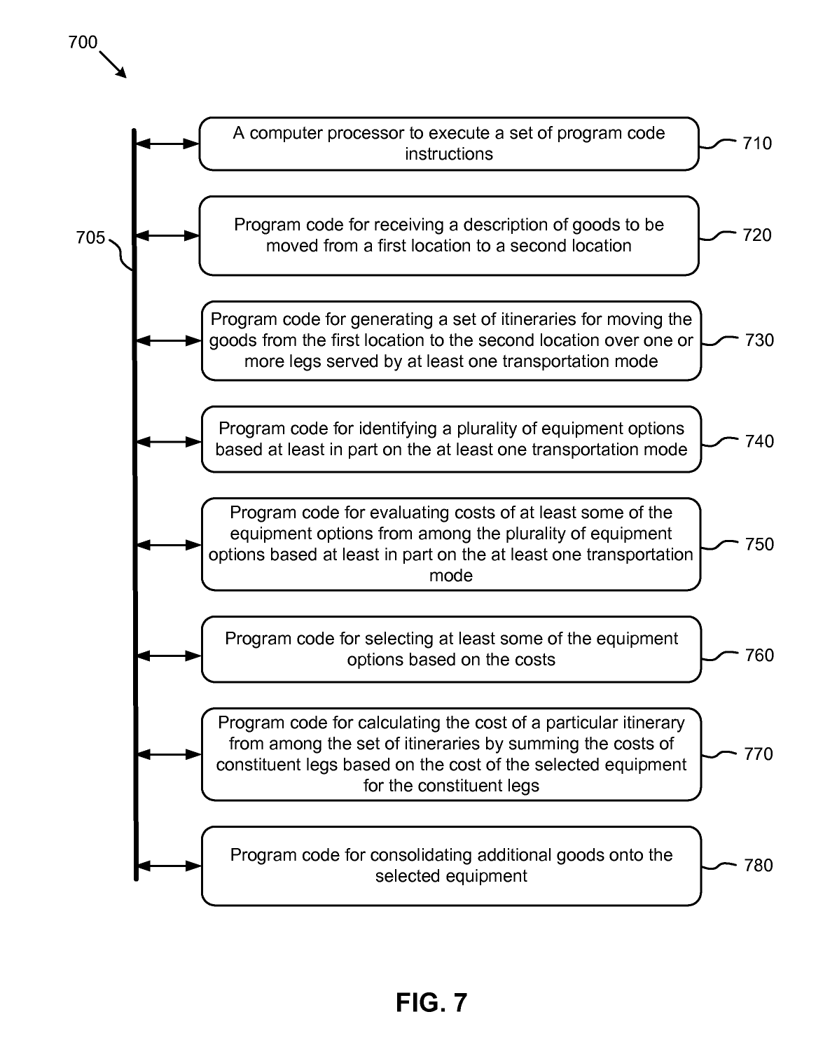

FIG. 7 is a block diagram of a system for concurrent determination of shipping mode and ship unit packing during transportation planning, according to some embodiments. As an option, the present system 700 may be implemented in the context of the architecture and functionality of the embodiments described herein. Of course, however, the system 700 or any operation therein may be carried out in any desired environment.

As shown, system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims. The embodiment of FIG. 7 implements a portion of a computer system, shown as system 700, comprising a computer processor to execute a set of program code instructions (see module 710) and modules for accessing memory to hold program code instructions to perform: receiving a description of goods to be moved from a first location to a second location (see module 720); generating a set of itineraries for moving the goods from the first location to the second location over one or more legs served by at least one transportation mode (see module 730); identifying a plurality of equipment options based at least in part on the at least one transportation mode (see module 740); evaluating costs of at least some of the equipment options from among the plurality of equipment options based at least in part on the at least one transportation mode (see module 750); and selecting at least some of the equipment options based on the costs (see module 760).

Some embodiments further include calculating the cost of a particular itinerary by summing the costs of constituent legs based on the cost of the selected equipment for the constituent legs (see module 770). Still further embodiments perform operations for consolidating additional goods onto the selected equipment (see module 780).

### System Architecture Overview

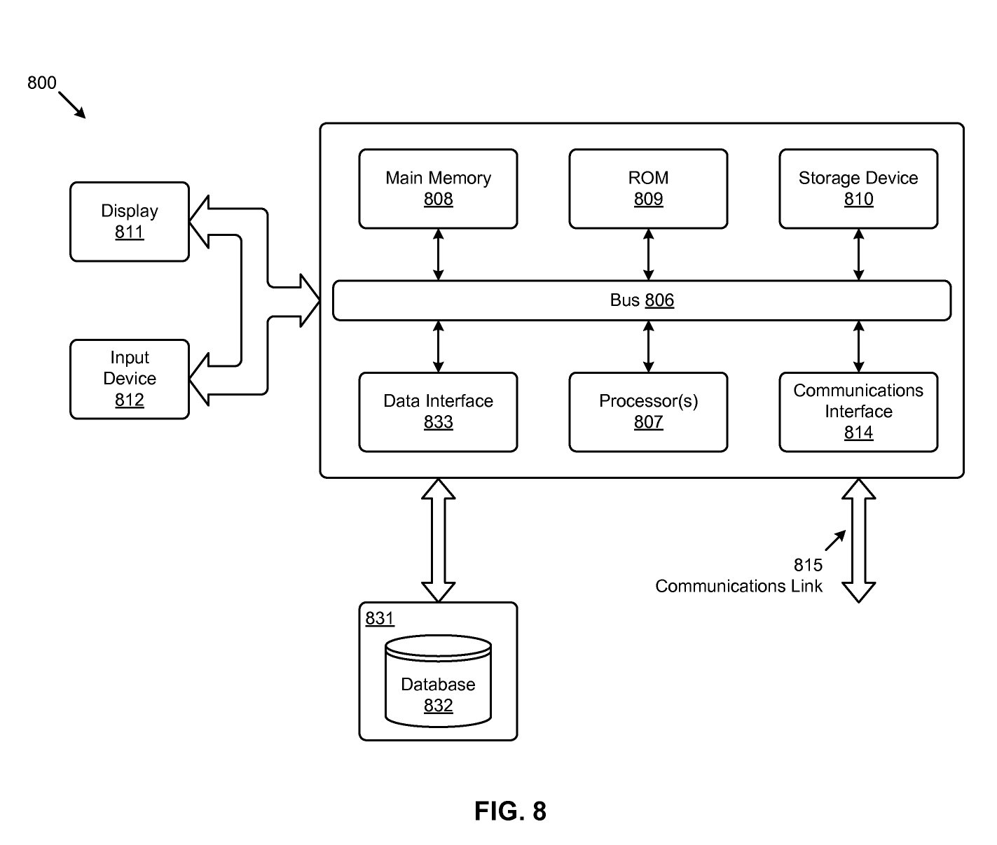

FIG. 8 depicts a block diagram of an instance of a computer system 800 suitable for implementing an embodiment of the present disclosure. Computer system 800 includes a bus 806 or other communication mechanism for communicating information, which interconnects subsystems and devices, such as a processor 807, a system memory 808 (e.g., RAM), a static storage device (e.g., ROM 809), a disk drive 810 (e.g., magnetic or optical), a data interface 833, a communication interface 814 (e.g., modem or Ethernet card), a display 811 (e.g., CRT or LCD), input devices 812 (e.g., keyboard, cursor control), and an external data repository 831.

According to one embodiment of the disclosure, computer system 800 performs specific operations by processor 807 executing one or more sequences of one or more instructions contained in system memory 808. Such instructions may be read into system memory 808 from another computer readable/usable medium, such as a static storage device or a disk drive 810. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 807 for execution. Such a medium may take many forms, including but not limited to, non-volatile media and volatile media. Non-volatile media includes, for example, optical or magnetic disks, such as disk drive 810. Volatile media includes dynamic memory, such as system memory 808.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 800. According to certain embodiments of the disclosure, two or more computer systems 800 coupled by a communications link 815 (e.g., LAN, PTSN, or wireless network) may perform the sequence of instructions required to practice the disclosure in coordination with one another.

Computer system 800 may transmit and receive messages, data, and instructions, including programs (e.g., application code), through communications link 815 and communication interface 814. Received program code may be executed by processor 807 as it is received, and/or stored in disk drive 810 or other non-volatile storage for later execution. Computer system 800 may communicate through a data interface 833 to a database 832 on an external data repository 831. A module as used herein can be implemented using any mix of any portions of the system memory 808, and any extent of hard-wired circuitry including hard-wired circuitry embodied as a processor 807.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A computer implemented method, the method comprising:
using a computing system having at least one processor to perform a process, the process comprising:
receiving a set of shipping mode options and a set of shipping unit options;
evaluating a plurality of combinations of using any of the set of shipping mode options corresponding to at least two different transportation carriers with at least one particular shipping unit option to determine a combination cost; and
determining a selected combination by selecting at least one of the plurality of combinations based at least in part on the combination cost.

2. The method of claim 1, wherein the selecting is based at least in part on a lowest combination cost.

3. The method of claim 1, further comprising calculating the cost of a particular itinerary from among a set of itineraries by summing costs of constituent legs based at least in part on the combination costs for the constituent legs.

4. The method of claim 3, further comprising selecting a particular itinerary based at least in part on the cost of the particular itinerary.

5. The method of claim 1, further comprising selecting equipment options that are compatible with the shipping unit option used in the selected combination.

6. The method of claim 1, further comprising packing goods into the shipping unit option of the selected combination.

7. The method of claim 1, further comprising consolidating partially-packed shipping units into more fully-packed shipping units.

8. The method of claim 1, wherein the combination cost is based at least in part on a number of shipping units.

9. A computer program product embodied in a non-transitory computer readable medium, the computer readable medium having stored thereon a sequence of instructions which, when executed by a processor causes the processor to execute a process, the process comprising:
receiving a set of shipping mode options and a set of shipping unit options;
evaluating a plurality of combinations of using any of the set of shipping mode options corresponding to at least two different transportation carriers with at least one particular shipping unit option to determine a combination cost; and
determining a selected combination by selecting at least one of the plurality of combinations based at least in part on the combination cost.

10. The computer program product of claim 9, wherein the selecting is based at least in part on a lowest combination cost.

11. The computer program product of claim 9, further comprising calculating the cost of a particular itinerary from among a set of itineraries by summing costs of constituent legs based at least in part on the combination costs for the constituent legs.

12. The computer program product of claim 11, further comprising selecting a particular itinerary based at least in part on the cost of the particular itinerary.

13. The computer program product of claim 9, further comprising selecting equipment options that are compatible with the shipping unit option used in the selected combination.

14. The computer program product of claim 9, further comprising packing goods into the shipping unit option of the selected combination.

15. The computer program product of claim 9, further comprising consolidating partially-packed shipping units into more fully-packed shipping units.

16. The computer program product of claim 9, wherein the combination cost is based at least in part on a number of shipping units.

17. A computer system comprising:
a receiving unit to receive a set of shipping mode options and a set of shipping unit options;
a calculator to evaluate a plurality of combinations of using any of the set of shipping mode options corresponding to at least two different transportation carriers with at least one particular shipping unit option to determine a combination cost; and
a selection unit to determine a selected combination by selecting at least one of the plurality of combinations based at least in part on the combination cost.

18. The computer system of claim 17, wherein the selecting is based at least in part on a lowest combination cost.

19. The computer system of claim 17, wherein the calculator calculates the cost of a particular itinerary from among a set of itineraries by summing costs of constituent legs based at least in part on the combination costs for the constituent legs.

20. The computer system of claim 17, wherein the combination cost is based at least in part on a number of shipping units.
